(19) United States
(12) Patent Application Publication
(10) Pub. No.: US 2007/0094652 A1
(43) Pub. Date: Apr. 26, 2007

(54) Lockless scheduling of decreasing chunks of a loop in a parallel program

(76) Inventors: Joshua J. Chia, Urbana, IL (US); Arch D. Robison, Champaign, IL (US); Grant E. Haab, Mahomet, IL (US)

Correspondence Address: TROP PRUNER & HU, PC, 1616 S. VOSS ROAD, SUITE 750, HOUSTON, TX, 77057-2631, US

(21) Appl. No.: 11/256,474

(22) Filed: Oct. 21, 2005

(51) Int. Cl. G06F 9/45

(52) U.S. Cl. 717/151

(57) ABSTRACT

A loop can be executed on a parallel processor by partitioning the loop iterations into chunks of decreasing size. An increase in speed can be realized by reducing the time taken by a thread when determining the next set of iterations to be assigned to a thread. The next set of iterations can be determined from a chunk index stored in a shared variable. Using a shared variable enables threads to perform operations concurrently to reduce the wait time to the period while another thread increments the shared variable.

### BACKGROUND

This invention relates generally to shared-memory parallel programs.

Shared-memory parallel programs comprise a plurality of threads that execute concurrently within a shared address space. For instance, different threads might concurrently compute the sum of different portions of a list of numbers.

A loop is a repetition within a program. Loops may be nested. A common method for applying multiple threads to execution of a loop is to partition the loop iterations across threads. By having threads perform various loop iterations concurrently, the loop can be executed faster than if a single thread performed all the iterations.

Shared-memory parallel programs can be written in a variety of programming languages. OpenMP is a specification for a set of compiler directives, library routines, and environment variables that can be used to specify shared memory parallelism for programs written in the Fortran, C, or C++ programming languages. See, for example, the OpenMP specification C/C++ Version 2.0 (March 2002) available from the OpenMP architecture group.

The term “iteration index”, in relation to a given loop iteration and its corresponding loop index, means the number of iterations that would precede the given loop iteration if the loop were executed sequentially. For example, when a loop is executed sequentially, the first loop iteration to be executed would have an iteration index of zero. The second loop iteration to be executed sequentially would have an iteration index of one and so forth. If the loop iterations are executed in parallel, the loop iterations still map to the same “iteration indices”. The iteration index does not have to start with zero, but a constant offset relative to the zero-based definition can be applied. An iteration index does not have to progress in increments of one, but may also progress in increments of another constant value.

### BRIEF DESCRIPTION OF THE DRAWINGS

FIG. 1 is a schematic drawing of a processor-based system implementing an embodiment of the present invention;

FIG. 2 depicts an apparatus for determining the initial iteration index and the number of iterations in the next chunk to be assigned in accordance with one embodiment; and

FIG. 3 depicts a flow chart for one embodiment of the present invention.

### DETAILED DESCRIPTION

The OpenMP specification contains a schedule clause that specifies how iterations of the loop are partitioned into contiguous, non-empty subsets, called chunks, and how these chunks are assigned among threads. A chunk is a contiguous subset of iterations of a loop and can have an initial iteration and a final iteration that defines the bounds of that chunk. The size of a chunk is the number of iterations it contains. A scheduling method can be used to determine when a chunk is assigned to a thread and which thread is assigned the chunk. OpenMP allows a programmer to specify one of several scheduling methods. In a static scheduling method, loop iterations are partitioned into chunks of the same size, and chunks are assigned to threads without regard to how much work each chunk involves. In a dynamic scheduling method, loop iterations are partitioned into chunks of the same size and each successive chunk is assigned to the next thread that finishes processing the previous chunk that it was assigned. In a guided scheduling method, loop iterations are partitioned into chunks of decreasing size, so that chunk size decreases progressively for successively assigned chunks, and each successive chunk is assigned to the next thread that finishes processing the previous chunk that it was assigned.

The relationship between iteration index and loop index allows one to be directly computed from the other.

The term “chunk index” in relation to a given chunk can mean the number of chunks that are assigned before the given chunk, so the first chunk to be assigned would have a chunk index of zero. In an embodiment of the invention, the chunk index used does not have to start with zero, but a constant offset relative to the zero-based definition may be applied. In an embodiment a chunk index does not have to progress in increments of one, but may also progress in increments of another value.

When a program executes guided scheduling, a contiguous set of iterations belonging to a chunk can be assigned to a successive thread as it requests the next set of iterations. The minimum chunk size can be at least one. A thread can request and obtain a chunk, and then execute the iterations of the chunk. A thread repeats these steps until no iterations remain to be assigned. To obtain a progressively decreasing size of successive chunks, the size of the successive chunks can be constrained to be proportional to the number of unassigned iterations. A constant relating chunk size and the number of unassigned iterations can be the number of threads, so that the size of a chunk is determined to be equal to the number of unassigned iterations divided by the number of threads multiplied by another constant. Integer rounding can be used when determining the chunk size. The minimum chunk size can be used for the chunk size when the size determined from the above computation is less than the minimum chunk size. A chunk cannot include iterations that do not exist in the loop, so the actual number of iterations in the last chunk may be less than the minimum chunk size.

In an embodiment of a guided scheduling method, the number of iterations that have been assigned can be represented in a shared variable, and the assignment of a chunk can be performed by reading the shared variable to obtain the number of iterations that have been assigned, using that value in some arithmetic computation to determine the initial and final iterations of the next chunk to be assigned, and then writing back an updated value to the shared variable reflecting the new chunk assignment. The actual value stored may not be the number of iterations that have been assigned. For example, it may be the number of iterations that have yet to be assigned. If two threads attempt to perform the above steps concurrently, they may end up obtaining the same chunk, so that the same chunk is executed twice. A lock can be used to prevent such situations. A thread can acquire the lock before reading the shared variable and release it after writing to it. The intervening arithmetic computation can involve several instructions, notably a division, which can take a significant amount of time. The use of the lock can reduce the speed of loop execution because each thread that is waiting to get another chunk must wait for its turn to acquire the lock, and the arithmetic computation can contribute to the length of time for which a thread holds the lock, and consequently the waiting time for the other threads.

To increase speed, some embodiments of the present invention can allow a thread to determine the initial and final iterations indices for the next chunk to be assigned without holding a lock and without using a shared variable that needs to be updated using lengthy computation involving division.

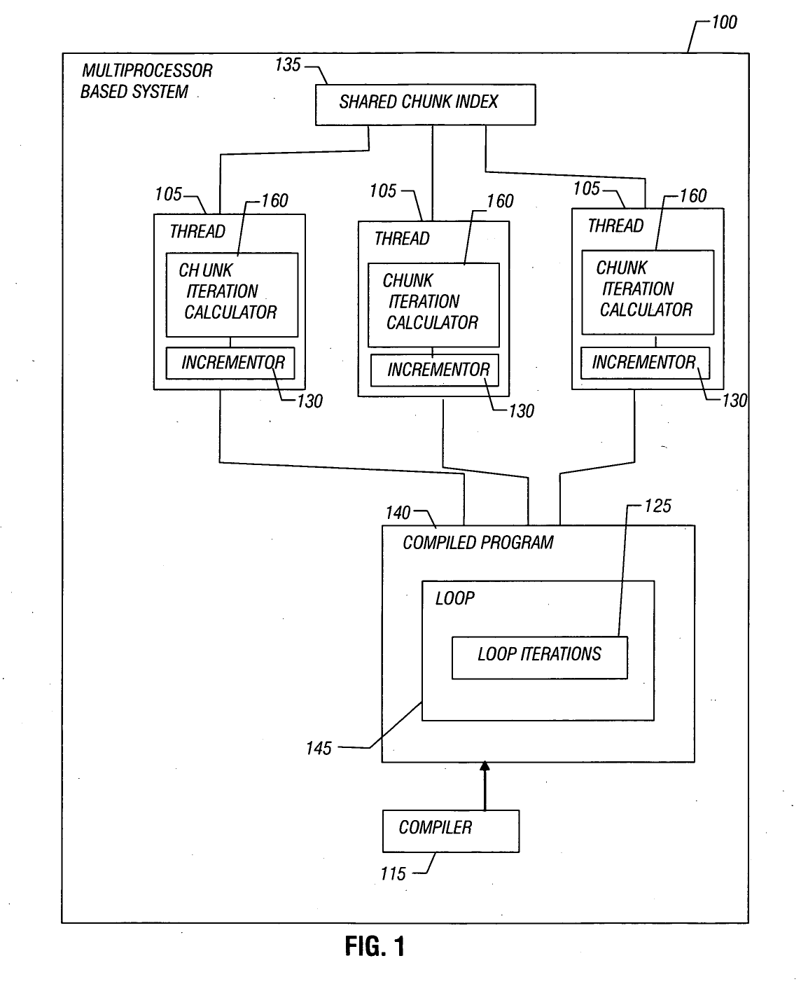

FIG. 1 depicts an embodiment of a multiprocessor-based system 100. The multiprocessor-based system 100 can include a compiler 115. The compiler can be a C/C++ compiler, a Fortran compiler, or any compiler that can create a compiled program 140 with a loop 145 or loops. Alternatively, the program may be interpreted instead of compiled, or some combination thereof (for example, “just in time” compilers). After a compiler creates a program 140, the multiprocessor-based system 100 can run the program 140. When a loop 145 is initialized within a program 140, a chunk of the loop 145 can be assigned to a thread 105.

When a thread 105 completes operations on the chunk assigned to the thread 105, the thread 105 can request the next chunk. The threads 105 can be executed on a multiprocessor or other multithreaded system. On a multiprocessor-based system 100, a processor can perform the operations of a thread. The operations of a thread 105 performed on a processor can include using the chunk iteration calculator 160 to determine the initial or final loop indices of a chunk from the shared chunk index 135.

The thread 105 requesting the next chunk can determine the initial and final iterations of the next chunk to be assigned from the initial iteration index and the number of iterations in the chunk. The initial iteration index and the number of iterations in the chunk can be determined from closed form equations based on the value of the shared chunk index 135, the total number of iterations 125 in a loop, and other parameters, for example, the number of threads.

The shared chunk index 135 can reside in a shared location in memory, or in a shared register. A chunk iteration calculator 160 can initialize the shared chunk index at the beginning of the loop 145, and each time a thread 105 requests a chunk, the chunk iteration calculator 160 can atomically read and increment the value of the shared chunk index 135 using the incrementor 130.

To atomically read and increment a variable means to read the value of the variable, increment the value by a given constant, then write the new value back to the variable, in such a way that any observable result is as if any other access to the same variable by another thread occurs strictly before the read step or after the write step, and not between the read step and the write step. For example, if two threads execute an atomic read and increment with an increment value of two on a variable whose initial value is zero, the final value has to be four. Without the above restriction on the observable result, it is possible for the final value to be two.

For example, atomic read and increment on a shared variable can be done by the fetch-and-add instructions found on processors with Intel® 32 bit architecture and Itanium® processors available from Intel® located in Santa Clara, Calif.

The increment does not have to be by one. The increment can be by values other than one depending upon the nature of the computer system. For example, if the low-order bit of the word is required for some other purpose, then incrementing by two can be advantageous.

Once the chunk iteration calculator 160 has obtained a chunk index, the chunk iteration calculator 160 can determine the initial and final loop indices of the next chunk without waiting on the other threads. When the thread finishes processing the chunk, the thread can request another chunk.

The initial and final loop indices of the next chunk can be determined without using loop or iteration index information about the previous chunk that was assigned, thus reducing the wait time to determine the initial and final loop indices.

Atomically reading and incrementing the value of the shared chunk index 135 can be performed with methods other than using processor instructions that directly support atomically reading and incrementing. For example, a lock can be acquired before the chunk index 135 is read and incremented and released after the new value has been written to the chunk index.

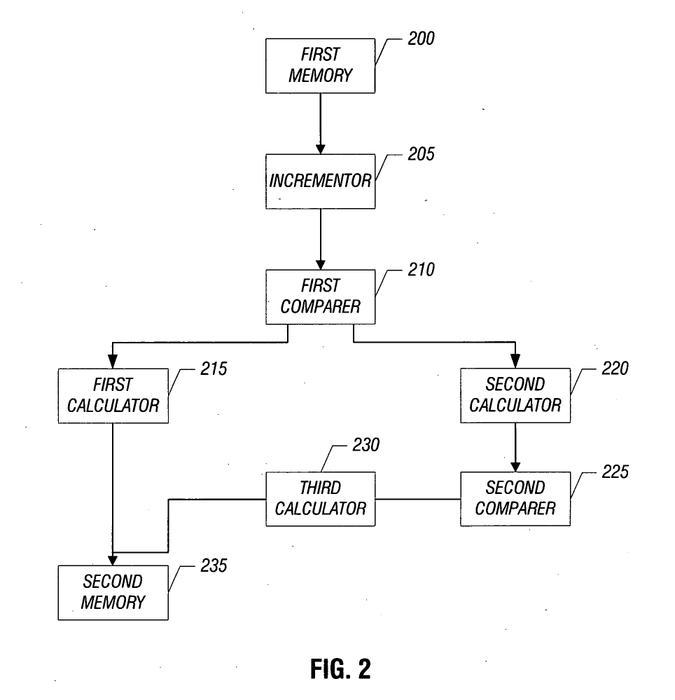

FIG. 2 depicts an embodiment of an apparatus for determining the initial iteration index and the number of iterations of the next chunk to be assigned to a thread when processing a loop in multiple chunks. When a thread 105 requests the next chunk to be assigned, the thread 105 can use the embodiment of FIG. 2. The apparatus of FIG. 2 can be used as the chunk iteration calculator 160, to determine the initial and final iterations indicies of the next chunk. The apparatus can include a first memory 200 that can store constants that can be pre-computed before a loop is initialized. The first memory can be shared by all threads executing the loop, or each thread can have a copy. After the constants have been pre-computed, an incrementor 205 can increment an index in one embodiment. The incrementor 205 can atomically read and increment the value of the index. The incrementor 205 can increment the index by any number based on the requirements of the system. For example, the incrementor 205 can increment the index by one.

After the incrementor 205 has incremented the index, a first comparator 210 can compare the retrieved index value to one of the loop constants. If the retrieved index value is smaller than the constant, a first calculator 215 can determine the initial iteration index and number of iterations in the next chunk to be assigned to a thread 105. If the retrieved index value is larger than or equal to the constant, a second calculator 220 can determine the initial iteration index of the next chunk to be assigned to a thread 105.

Once the initial iteration index of the next chunk to be assigned to a thread is determined by a second calculator 220, a second comparator 225 can compare the initial iteration to the total number of iterations in the loop. If the initial iteration index is less than the total number of iterations in the loop, then the third calculator 230 can determine the number of iterations in the next chunk. If the initial iteration index is larger than or equal to the total number of iterations in the loop, all the chunks have been assigned and the apparatus may not return a value. Once the initial iteration index and number of iterations in the next chunk to be assigned have been determined by the first, second, or third calculators 215, 220 or 230, these values can be stored in the second memory 235.

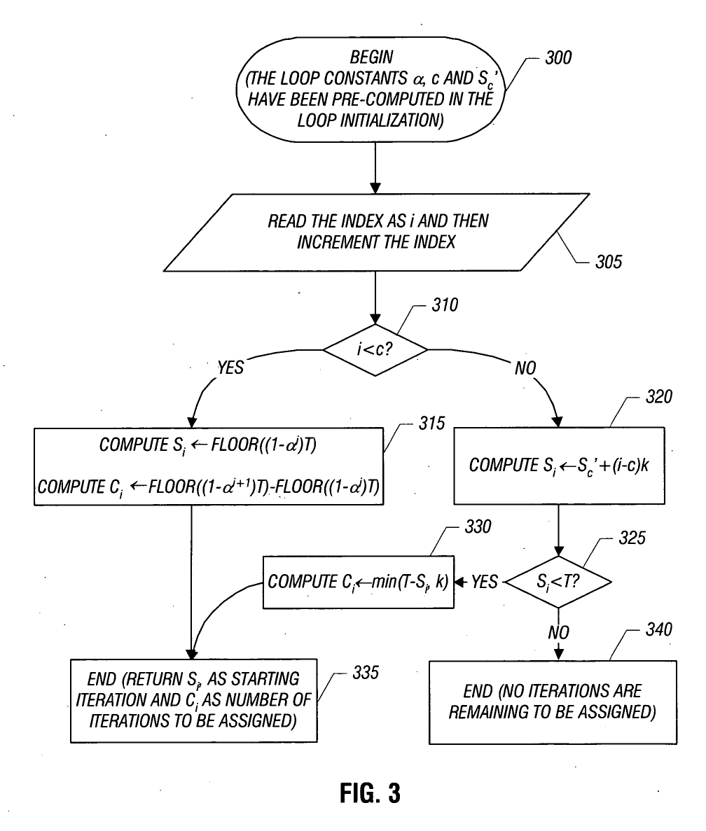

FIG. 3 depicts a flow chart of an embodiment for a method of determining the initial iteration index and the number of iterations of the next chunk to be assigned to a thread. The method of FIG. 3 can be implemented by hardware, software, or firmware. When the method is implemented by software, the instructions to perform the method can be stored on a computer readable medium. The method begins at 300 by pre-computing the constants α, c, and S_{c}′, in one embodiment. The constant α can be equal to 1-1/(2n), where n can be the number of threads in one embodiment. In one embodiment the constant c can equal to ceil(log_{α}((2k+1)n/T)), where k can be the user-specified minimum number of iterations in a chunk, n can be the number of threads, and T can be the total number of iterations in the loop. Here, the function “ceil(x)” denotes the least integer that is equal to or greater than x. The constant S_{c}′ can be equal to floor((1−α^{c})T) in one embodiment. Here, the function “floor(x)” denotes the greatest integer that is equal to or less than x. Although the constants have been defined by formulas, some embodiments are not restricted to these formulas. When a guided scheduler is used to execute a loop, a parameter k can be specified, where k is the minimum number of iterations that a chunk can contain. When the number of remaining iterations is less than k, the remaining iterations can still be assigned in one chunk, so that the size of that chunk can be specially allowed to be less than k.

After the constants α, c, S_{c}′ have been pre-computed, an index can be atomically read and incremented at 305, where the index can be incremented by one or another number based on the requirements of a system implementing the method. The read value i can be the value immediately preceding the increment. The read value i is used in determining the initial iteration and the number of iterations in a chunk because the index could be incremented many times by other threads while a thread is determining its next chunk. Next the variable i can be compared to the constant c 310. If variable i is less than c, then at 315, Sᵢ, the initial iteration index of the next unassigned chunk, can be determined from floor((1−αⁱ)T) and Cᵢ, the number of iterations to be assigned can be determined from floor((1−αⁱ⁺¹)T)-floor((1−αⁱ)T). An increase in the number of iterations in the next unassigned chunk relative to the size of the previously assigned chunk can occur using the formulas for Sᵢ and Cᵢ. The initial iteration index Sᵢ and the number of iterations Cᵢ of the next chunk to be assigned can be returned at 335. The initial iteration index and the number of iterations in the next chunk can be used to determine the initial and final loop indices of the next chunk to be assigned. The next chunk can then be assigned to a thread. When, at 310, i is greater than or equal to c, the initial iteration index of the next unassigned chunk, Sᵢ can be determined from S_{c}′+(i-c)k, 320. At 325, the starting iteration index Sᵢ, determined in 320, can be compared to T, the total number of iterations in the loop. If Sᵢ is less than T, then Cᵢ, the number of iterations to be assigned can be determined from min(T-Sᵢ,k), at 330. The initial iteration index, Sᵢ and the number of iterations, Cᵢ can be returned 335 and assigned to a thread. The loop can end because there are no iterations remaining to be assigned at 340, when at 325 Sᵢ is greater than or equal to T.

If the comparison at diamond 310 between the index and c were not performed so that the ‘yes’ path is unconditionally taken, the resulting computation at block 315 might yield a value for the number of iterations that is less than k or even zero while there are still at least k unassigned iterations. This anomaly can be prevented by performing the check at diamond 310. The check at diamond 325 can determine if the loop has ended or whether there are iterations remaining that need to be assigned.

In method 300, when the embodiment begins the constants that are calculated can be calculated once for each loop. In a multithreaded system, the threads can each calculate the constants independently. Allowing each thread to compute the constants can increase the speed of the system by not waiting for one thread to complete the calculations and send the values of the constants to the other threads. If the same loop is reinitialized after the loop has been completed previously the threads can recalculate the constants.

An atomic read and increment step can increment the shared chunk index at 305. This instruction can stop the other threads from accessing the index before the incrementing of the index is complete. Using an atomic operation, such as fetch-and-add, compare-and-swap, or fetch-and-subtract, can avoid the bottleneck that can result from holding a lock. Since only one thread can hold a lock at one time other threads must wait their turn to acquire the lock. This can introduce long delays if the thread that owns the lock is interrupted, or performs a long calculation while holding the lock. An advantage of the atomic operation is that other threads are not able to access the variable during the operation because of the operation's indivisible and uninterruptible nature, and hence no lock is necessary. To achieve the effect of reading and incrementing the chunk index atomically, an alternative to using an indivisible and uninterruptible instruction is to acquire a lock, perform a non-atomic read, followed by a non-atomic increment, and then to release the lock. This would still allow the operation to be completed faster than if a division operation were performed while holding a lock.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining from an index at least one of an initial iteration and a final iteration of a chunk of a loop with a plurality of iterations.

2. The method of claim 1, further comprising storing the index in a shared variable.

3. The method of claim 1, further comprising incrementing the index.

4. The method of claim 3, further comprising performing the incrementing by an indivisible and uninterruptible operation.

5. The method of claim 1, further comprising incrementing the index by one.

6. The method of claim 1, further comprising assigning the chunk to a thread.

7. The method of claim 1, further comprising determining the final iteration from the initial iteration and a number of iterations in the chunk.

8. The method of claim 1, further comprising determining the initial iteration from the final iteration and a number of iterations in the chunk.

9. A computer readable medium comprising instructions that, if executed, enable a processor-based system to:
determine from an index at least one of an initial iteration and a final iteration of a chunk of a loop with a plurality of iterations.

10. The computer readable medium of claim 9, further storing instructions that, when executed, enable the processor-based system to: store the index in a shared variable.

11. The computer readable medium of claim 9, further storing instructions that, when executed, enable the processor-based system to: increment the index.

12. The computer readable medium of claim 11, further storing instructions that, when executed, enable the processor-based system to: perform the incrementing by an indivisible and uninterruptible operation.

13. The computer readable medium of claim 9, further storing instructions that, when executed, enable the processor-based system to: increment the index by one.

14. The computer readable medium of claim 9, further storing instructions that, when executed, enable the processor-based system to: assign the chunk to a thread.

15. The computer readable medium of claim 9, further storing instructions that, when executed, enable the processor-based system to: determine the final iteration from the initial iteration and a number of iterations in the chunk.

16. The computer readable medium of claim 9, further storing instructions that, when executed, enable the processor-based system to: determine the initial iteration from the final iteration and a number of iterations in the chunk.

17. An apparatus comprising:
a shared memory parallel program; and
a scheduler coupled to the shared memory parallel program to determine from an index at least one of an initial iteration and a final iteration of a chunk of a loop with a plurality of iterations.

18. The apparatus of claim 17, including an incrementor coupled to the scheduler to increment the index.

19. The apparatus of claim 17, including the shared memory parallel program to generate instructions.

20. The apparatus of claim 19, including a processor to process the instructions.

21. The apparatus of claim 17, including the scheduler to determine the final iteration from the initial iteration and a number of iterations in the chunk.

22. The apparatus of claim 17, including the scheduler to determine the initial iteration from the final iteration and a number of iterations in the chunk.

23. A system comprising:
a shared memory parallel program;
a scheduler coupled to the shared memory parallel program to determine from an index at least one of an initial iteration and a final iteration of a chunk of a loop with a plurality of iterations; and
a compiler to generate instructions to process the chunk.

24. The system of claim 23, including an incrementor coupled to the scheduler to increment the index.

25. The system of claim 23, including a processor to process the instructions.

26. The system of claim 23, including the scheduler to determine the final iteration from the initial iteration and a number of iterations in the chunk.

27. The system of claim 23, including the scheduler to determine the initial iteration from the final iteration and a number of iterations in the chunk.
